(19) United States
(12) Patent Application Publication
(10) Pub. No.: US 2006/0067350 A1
(43) Pub. Date: Mar. 30, 2006

(54) Method of assigning network identifiers by means of interface identifiers

(75) Inventors: Laurent Clevy, Chartres (FR); Guillaume Ivaldi, Agoura Hills, CA (US)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/231,948

(22) Filed: Sep. 22, 2005

(30) Foreign Application Priority Data
Sep. 23, 2004 (FR) 0452145

(51) Int. Cl. H04L 12/56; H04L 12/28

(52) U.S. Cl. 370/419

(57) ABSTRACT

A method is dedicated to dynamically assigning interface network identifiers for interfaces of network equipments connected to an Internet Protocol communication network including a DHCP network identifier server. In this method, when a network equipment requires an interface network identifier for one of its interfaces, designated by an interface identifier and connected to a link: i) there is generated in the network equipment and sent to the server a request for the assignment of an interface network identifier specifying the identifier of the interface that is the subject of the request and the identifiers of the other interfaces connected to the link; ii) on receipt of the request in the server, there is determined for the interface that is the subject of the request an interface network identifier common to all the interfaces connected to the same link; iii) the interface network identifier thus determined is sent to the network equipment that requested it so that it can configure the interface.

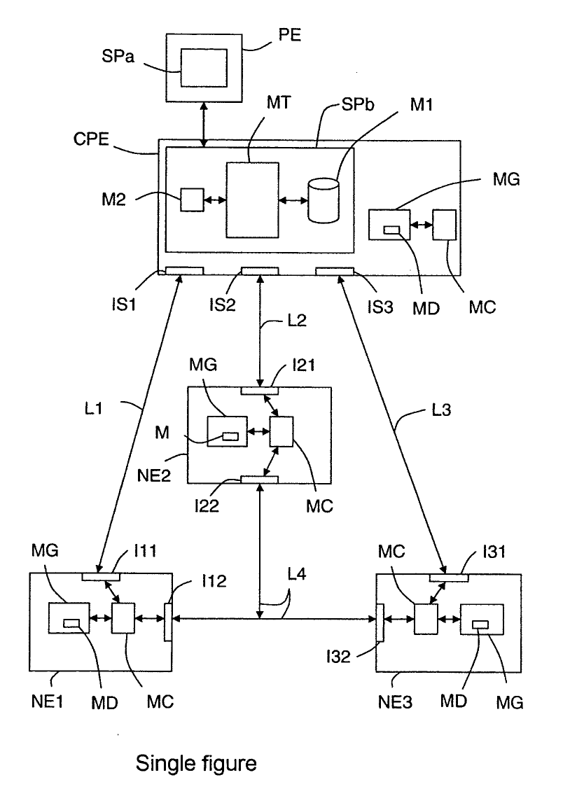

### CROSS-REFERENCE TO RELATED APPLICATIONS

This application is based on French Patent Application No. 0452145 filed 23/09/2004, the disclosure of which is hereby incorporated by reference thereto in its entirety, and the priority of which is hereby claimed under 35 U.S.C. § 119.

### BACKGROUND OF THE INVENTION

1. Field of the Invention

The field of the invention is that of Internet Protocol (IP) networks, to be more precise the methods used in IP networks to assign network identifiers to network equipment communication interfaces.

2. Description of the Prior Art

The person skilled in the art knows that, for network equipments, for example routers, to be able to communicate with each other within an IP network, it is essential that their communication interfaces are configured accordingly by means of a network identifier supplied, for example, by a network identifier server belonging to said IP network.

The network identifier is one of the two portions of the IP address of an interface, the other portion being its interface identifier. The network identifier is generally defined by the 64 left-most bits of the IP address, of which 48 bits define a prefix, and the interface identifier is generally identified by the 64 right-most bits of the IP address.

In the case of an IP version 6 (IPv6) network, for example, the network equipments and the server use a Dynamic Host Configuration Protocol (DHCP) to assign the network identifiers of the interfaces.

The interface network identifier assignment method generally comprises two steps. The first step generates in a network equipment a request that is sent to the identifier server of the network to assign an interface network identifier for one of its interfaces. In the second step the network identifier server that receives the request determines an interface network identifier for the interface that is the subject of the request, after which the interface network identifier thus determined is sent to the network equipment that submitted the request in order for it to configure its interface taking account of the received interface network identifier.

This method supplies interface network identifiers that are suitable for configuring interfaces in many situations. However, this is not the case if the interface network identifiers are assigned to interfaces that are connected to the same link and are therefore adapted to communicate directly with each other. This is because current network identifier servers are not capable of detecting interconnections between network equipments.

To attempt to solve this problem in IPv6 networks including network equipments and servers using version 6 of the dynamic host configuration protocol (DHCPv6), the Internet engineering task force (IETF) has proposed the use of hierarchical prefix delegation (HPD), which is described in particular in the document “draft-bykim-ipv6-hpd-01.txt”, ETRI, 15 Feb. 2004, available at the following URL: http://ietfreport.isoc.org/all-ids/draft-bykim-ipv6-hpd-01.txt.

The above solution is certainly promising, but it raises security and flexibility problems that necessitate the provision of additional mechanisms, likely to be complex, as yet unknown and so as to limit their use by the clients to whom the network equipments belong.

No interface network identifier assignment method known in the art proves to be entirely satisfactory. An object of the invention is therefore to improve on this situation.

### SUMMARY OF THE INVENTION

To this end the invention proposes a method of dynamically assigning interface network identifiers for interfaces of network equipments connected to an Internet Protocol communication network including a DHCP network identifier server, in which method, when a network equipment requires an interface network identifier for one of its interfaces, designated by an interface identifier and connected to a link: i) there is generated in the network equipment and sent to the server a request for the assignment of an interface network identifier specifying the identifier of the interface that is the subject of the request and the identifiers of the other interfaces connected to the link; ii) on receipt of the request in the server, there is determined for the interface that is the subject of the request an interface network identifier common to all the interfaces connected to the same link; iii) the interface network identifier thus determined is sent to the network equipment that requested it so that it can configure the interface.

The method of the invention may have the following additional features, either separately or in combination, and in particular:
each interface network identifier thus determined may be stored in a table in the server in corresponding relationship to the interface identifiers received that are associated with the same link and constitute a set,
the determination of the interface network identifier may then consist in determining whether at least one of the interface identifiers received in a request is identical to one of the interface identifiers of a stored set, in order to assign to the interface that is the subject of the request an interface network identifier that is either that stored in corresponding relationship to one of the sets in the event of identity or is new in the absence of identity,
in the event of assignment of a new interface network identifier, each new interface network identifier may be stored in the table in the server in corresponding relationship to the received set of interface identifiers,
in the event of identity between at least one of the interface identifiers received in a request and one of the interface identifiers of a stored set, whether the set of interface identifiers received is entirely identical to the stored set may be determined, in order to update the stored set in the event of incomplete identity,
a sequence identifier may be integrated into the request for assignment of an interface network identifier to enable it to be sent to the server in the form of a sequence of packets each including the same sequence identifier,
in the event of a requirement to assign an interface network identifier for an interface connected to a link, the identifiers of the interfaces connected to the same link are determined, in the network equipment to which the interface belongs,
the determination may then be effected using a neighbor interface discovery protocol, for example the NDP protocol (each interface identifier determined then being a link local address).

The invention also proposes a server for dynamically assigning DHCP interface network identifiers for the IP configuration of interfaces of network equipments connected to an Internet protocol communication network, which server comprises processing means adapted, in the event of reception of a request to assign an interface network identifier of the above type, for determining for the interface that is the subject of the request an interface network identifier common to all the interfaces connected to the same link, in order to transmit the interface network identifier thus determined to the network equipment that requested it in order for it to configure the interface.

The server may comprise a memory adapted to store each interface network identifier determined by the processing means in a table in corresponding relationship to the interface identifiers received and associated with the same link. In this case, the processing means may be adapted to determine if at least one of the interface identifiers received in a request is identical to one of the interface identifiers of a set stored in the memory and then to assign to the interface that is the subject of the request an interface network identifier that is either that stored in corresponding relationship to one of the sets in the event of identity or is new in the event of absence of identity. The processing means may then be adapted, in the event of assignment of a new interface network identifier, to store each new interface network identifier in the table of the memory in corresponding relationship to the set of interface identifiers received. The processing means may also be adapted, in the event of identity between at least one of the interface identifiers received in a request and one of the interface identifiers of a stored set, to determine if the set of interface identifiers received is entirely identical to the stored set and then to update the stored set in the memory in the event of incomplete identity.

This kind of server may form part, at least partially, of a DHCP IP router.

The invention also proposes a network equipment for an Internet Protocol communication network including a server for dynamically assigning DHCP type interface network identifiers, the equipment including at least one interface connected to a link and associated with an interface identifier, and management means adapted, if this interface has to be configured by means of an interface network identifier, to generate and to send to the server a request for assignment of an interface network identifier specifying the identifier of the interface and the identifiers of the other interfaces connected to the link.

For example, the management means may be adapted to integrate into the interface network identifier assignment request a sequence identifier to enable it to be sent to the server in the form of a sequence of packets each including the same sequence identifier.

Also, the management means may be adapted, in the event of a requirement to assign an interface network identifier for the interface, to determine the identifiers of the interfaces connected to the same link. In this case, the network equipment may comprise determination means adapted to determine, by means of a neighbor interface discovery protocol (for example the NDP protocol), an identifier for the interface to be configured and identifiers for the interfaces connected to the same link as the interface to be configured, and wherein the management means are adapted, by means of the determination means, to determine the identifier of the interface to be configured and the identifiers of the other interfaces connected to the same link.

Other features and advantages of the invention will become apparent on reading the following detailed description and examining the appended drawing, the single FIGURE of which shows diagrammatically a portion of an IP network including one embodiment of a network identifier server and embodiments of network equipments adapted to implement the invention.

### BRIEF DESCRIPTION OF THE DRAWINGS

The appended drawing constitutes part of the description of the invention as well as contributing to the definition of the invention, if necessary.

### DETAILED DESCRIPTION OF THE PREFERRED EMBODIMENT

An object of the invention is to enable assignment of interface network identifiers to equipment interfaces of an Internet Protocol (IP) communication network taking account of links set up between the interfaces.

For the purposes of illustrative example, the communication network referred to hereinafter is an IPv6 network. The invention is not limited to an IPv6 network, however. It relates to all IP communication networks and in particular to IPv4 networks.

In the non-limiting example shown in the single FIGURE, the IP network includes a network identifier server SPa, SPb coupled via respective links L1, L2 and L3 to three network equipments NE1, NE2 and NE3 which are coupled to each other by a link L4. The invention is not limited to this number of network equipments NEi or to this coupling between network equipments NEi (here i=1 to 3). It relates to any network configuration including at least one network identifier server SPa, SPb connected to at least two network equipments NEi (i>1) interconnected by a link L.

As shown in the single FIGURE, the interface network identifier server SPa, SPb (hereinafter referred to as the server SP) has a first portion SPa installed in an edge router PE of an Internet service provider (ISP) and a second portion SPb installed in a router CPE belonging to the proprietor of the network equipments NEi and connected via a link to the edge router PE.

Here the router CPE includes at least three interfaces ISi (here i=1 to 3) connected to three respective communication links Li.

The second portion SPb of the server SP comprises a processing module MT for determining the interface network identifiers for the interfaces Iij of the network equipments NEi to which the interfaces ISj of the router CPE are coupled by the links Li.

Each network equipment NEi (hereinafter referred to as an equipment) here has two interfaces Iij (here j=1 and 2, but j could take any value), whereof one Ii1 is connected to one of the interfaces ISj of the router CPE via the link Li and the other Ii2 is connected to the link L4.

The network equipments may be of any type provided that they include Internet Protocol (IP) communication interfaces having interface addresses with a common network identifier if they share the same link. Thus they may be IP routers, for example.

Moreover, each equipment NEi includes a conventional configuration module MC for configuring its various interfaces Iij taking into account, in particular, interface network identifiers assigned to each of them by the server SP, in accordance with the invention.

It is considered hereinafter that the server SP and the equipments NEi are all adapted to use a Dynamic Host Configuration Protocol (DHCP) to assign interface network identifiers. They preferably use version 6 of the Dynamic Host Configuration Protocol (DHCPv6), as defined by IETF standard RFC-3315. Other versions of DHCP may be used, for example the DHCP Prefix Option version defined by IETF standard RFC-3531.

Each equipment NEi includes a management module MG for generating a request for assignment of an interface network identifier that is sent to the server SP each time that one of the interfaces Iij must be the subject of an IP configuration by the associated configuration module MC.

According to the invention, each request generated includes the identifier of the interface Iij to be configured and the identifiers of the other interfaces that are connected to the same link L4.

Hereinafter, to simplify the description, the references Iij designate without distinction the interfaces and their respective identifiers. This is not the case in practice, of course.

Each equipment NEi includes a module MD for determining neighbor interface identifiers for determining its own list or lists of neighbor interfaces.

As shown here, this kind of determination module MD may form part of the management module MG. Alternatively, it may be independent of the latter but coupled to it.

For example, in the case of a DHCP equipment NEi, the determination module MD may be adapted to determine the identifiers of the neighbor interfaces of the interfaces Iij by means of a neighbor interface discovery protocol such as the Neighbor Discovery Protocol (NDP-IPv6) defined by IETF standard RFC-2641.

According to IETF standard RFC-2641, when an equipment NEi is powered up, its determination module MD automatically determines for each of its interfaces Iij an identifier called the link local address and including the interface network identifier FE80::/11. Each of its identifiers (or addresses) is then compared by the determination module MD to the identifiers (or addresses) determined by the neighbor equipments for their own interfaces, to assure its uniqueness. This comparison is effected by means of the Duplicate Address Detection (DAD) protocol. The determination module MD therefore has lists of identifiers of the neighbor interfaces of each interface Iij of its equipment NEi.

Thus if the management module MG has to generate an interface network identifier assignment request, it can interrogate the determination module MD to obtain the identifier of the interface to be configured and the list of the identifiers of the (neighbor) interfaces that are connected to the same link L4.

It may also be envisaged that the management module MG makes the determination module MD responsible for determining the list of identifiers of the neighbor interfaces of an interface Iij of its equipment as soon as it is made responsible for generating an interface network identifier assignment request for that interface Iij.

As soon as the management module MG has the identifier of the interface Iij to be configured and the list of the identifiers of the (neighbor) interfaces that are connected to the same link L4, it can integrate them into an interface network identifier assignment request sent to the server SP by its equipment NEi.

Because a list may include a large number of interface identifiers, the volume occupied by the list may be greater than that reserved for payload data within a packet to be transmitted. Consequently, the management module MG may also be adapted to integrate into the interface network identifier assignment request a sequence identifier (for example a number) so that it can be sent to the server SP in the form of a sequence of packets each containing the same sequence identifier and a portion of the list of the identifiers of the neighbor interfaces.

When the server SP receives an interface network identifier assignment request from an equipment NEi, it forwards it to its processing module MT, where applicable after reconstituting it (when it takes the form of a sequence of packets).

The processing module MT extracts from the request the identifier of the interface Iij that is to be configured (and is the subject of the request), together with the identifiers of the neighbor interfaces. It then determines an interface network identifier common to all the interfaces that are connected to the same link and communicates it to its server SP in order for it to send it to the equipment NEi that sent the request so that it may configure the interface Iij concerned.

As shown, the server SP preferably comprises a memory M1, for example in the form of a table of correspondences, coupled to the processing module MT and adapted to store each interface network identifier determined in corresponding relationship to the identifier of the interface Iij to be configured and the identifiers of the neighbor interfaces, which together constitute a received set (associated with the same link).

For example, if all the interfaces Iij of the equipments NEi of the network shown have been configured and are therefore associated with interface network identifiers Pi, the correspondence table includes the following four multiplets: (P1, I11, IS1) for the link L1, (P2, I21, IS2) for the link L2, (P3, I31, IS3) for the link L3 and (P4, I12, I22, I32) for the link L4. The expression “stored identifier set” means the set of interface identifiers contained in a stored multiplet.

In the presence of this kind of memory M1, when the processing module MT has a received set of identifiers, it determines if at least one of the interface identifiers of the received set is identical to one of the interface identifiers of one of the sets contained in the multiplets stored in the memory M1.

If so, the processing module MT assigns to the interface to be configured the interface network identifier that is contained in the multiplet containing the stored set that includes an identifier identical to one of the identifiers of the received set.

If not, i.e. if there is no identity, the processing module MT is faced with a new set associated with a new, unlisted link. It then determines a new interface network identifier, as yet not assigned to the interfaces of the known links, for the interface to be configured and more generally for all the interfaces constituting the new set.

The processing module MT chooses each new interface network identifier from a set of stored interface network identifiers, for example, as shown here, in a memory M2 to which it is coupled (but which it may equally comprise). This choice is effected in a manner that is known in the art.

Once the processing module MT has determined a new interface network identifier for an interface to be configured, it generates a message containing said interface network identifier and sends the message to its server SP in order for the latter to forward it to the equipment NEi that sent the request. The equipment NEi then forwards the message to its configuration module MC which then takes charge of configuring the interface Iij concerned, taking account in particular of the interface network identifier assigned to it by the server SP.

Moreover, once the processing module MT has determined a new interface network identifier for an interface to be configured, it generates a new multiplet including the new interface network identifier Pj in corresponding relationship with the new set of identifiers received. This makes it possible to enrich the table of correspondences stored in the memory M1 and therefore to facilitate the mechanism for assigning interface network identifiers. Accordingly, when the processing module MT receives a request concerning an interface whose identifier is included in the new stored multiplet, it will merely have to assign it automatically the interface network identifier included in said new multiplet.

The processing module MT is also preferably adapted to update a multiplet of the correspondence table if the set of identifiers that it contains is not completely identical to a set of identifiers received in a request. Updating a multiplet consists in replacing the stored set with the received set, for example, retaining its interface network identifier. This is particularly advantageous as in IP networks the sets containing interfaces respectively connected to common links frequently vary.

The invention is particularly advantageous because, when a new interface network identifier is assigned following the reception of a new set of identifiers, no delay is required to verify whether a new interface network identifier of this kind is necessary or not.

It is important to note that the mode of assigning an interface network identifier for an interface Iij of an equipment NEi may equally be applied to the interfaces of the router CPE in which the second portion SPb of the server SP is installed. The router CPE then requires a management module MG, a neighbor interface identifier determination module MD and a configuration module MC.

The processing module MT, the memories M1 and M2, the management module MG, the neighbor interface identifier determination module MD and the configuration module MC can take the form of electronic circuits, software (or data processing) modules, or a combination of circuits and software.

An example of the use of the invention is described next with reference to the examples shown in the single FIGURE.

In that example, the equipment NE1 requires to configure its interface I12 so that it can communicate directly with the interfaces I22 and I32 of the neighbor equipments NE2 and NE3 connected to the link L4.

By means of the determination module MD, the management module MG of the equipment NE1 determines the identifier of the interface I12 to be configured and the identifiers of the neighbor interfaces I22 and I23 that are connected to the same link L4. It then integrates those identifiers (I12, I22, I23) into an interface network identifier assignment request that its equipment NE1 sends to the server SP.

On receiving the request, the server SP forwards it to its processing module MT, which extracts from it the set of identifiers (I12, I22, I23). It then determines an interface network identifier common to the three interfaces connected to the link L4. To this end, it accesses the memory M1 in order to compare the identifiers contained in the received set (I12, I22, I23) to the identifiers contained in the stored sets.

If the memory M1 includes the multiplet (P4, I12, I22, I32), there is complete identity between the received and stored sets, and so the processing module MT assigns the interface network identifier P4 to the interface I12. It then generates a message including the interface network identifier P4 and sends it to its server SP in order for it to forward it to the equipment NE1, which then forwards it to its configuration module MC, which then takes charge of configuring the interface 112.

If the memory M1 includes a multiplet (P4, I22, I32), there is partial identity between the received and stored sets, and so the processing module MT assigns the interface network identifier P4 to the interface I12. The processing module MT then updates the memory M1 by replacing the old multiplet (P4, I22, I32) with a new multiplet (P4, I12, I22, I32). It then, or at substantially the same time, generates a message including the interface network identifier P4 and sends it to its server SP which then forwards it to the equipment NE1 which then forwards it to its configuration module MC which then takes charge of configuring the interface I12.

If the memory M1 now contains no multiplet containing any of the received identifiers I12, I22 and I32, the processing module MT is faced with a new set and chooses a new and as yet unassigned interface network identifier from the interface network identifiers stored in the memory M2. The processing module MT then generates a new multiplet (P4, I12, I22, I32) and stores it in the memory M1. It then, or at substantially the same time, generates a message including the interface network identifier P4, which it sends to its server SP which then forwards it to the equipment NE1 which then forwards it to its configuration module MC which then takes charge of configuring the interface I12.

The invention may equally be considered to constitute a method of dynamically assigning interface network identifiers for interfaces Iij of DHCP network equipments NEi.

The method of the invention may in particular be implemented with the aid of the network equipments NEi and the server SP described above. The main and optional functions and sub-functions of the steps of the method being substantially identical to those of the means constituting the network equipments NEi and the server SP, there are summarized hereinafter only the steps implementing the main functions of the method of the invention.

In the method of the invention, when a network equipment NEi requires an interface network identifier for one of its interfaces Iij (designated by an interface identifier and connected to a link L4), firstly generates in that network equipment Nei and sends to the network identifier server SP a request for assignment of an interface network identifier specifying the identifier of the interface Iij that is the subject of the request as well as the identifiers of the other interfaces that are connected to the same link L4; secondly, when the request is received by the network identifier server SP, it determines for the interface Iij that is the subject of the request an interface network identifier common to all the interfaces connected to the same link L4 as it; thirdly, it sends the interface network identifier that has been determined in this way to the network equipment NEi that requested an identifier, so that it can configure its interface Iij.

The invention is not limited to the embodiments of the network identifier server, router, network equipment and interface network identifier assignment method described above by way of example only, and encompasses all variants that the person skilled in the art might envisage that fall within the scope of the following claims.

1. A method of dynamically assigning interface network identifiers for interfaces of network equipments connected to an Internet Protocol communication network including a DHCP network identifier server, in which method, when a network equipment requires an interface network identifier for one of its interfaces, designated by an interface identifier and connected to a link: i) there is generated in said network equipment and sent to said server a request for the assignment of an interface network identifier specifying the identifier of the interface that is the subject of the request and the identifiers of the other interfaces connected to said link; ii) on receipt of said request in said server, there is determined for said interface that is the subject of said request an interface network identifier common to all the interfaces connected to the same link; iii) said interface network identifier thus determined is sent to said network equipment that requested it so that it can configure said interface.

2. The method according to claim 1, wherein each interface network identifier thus determined is stored in a table in said server in corresponding relationship to the interface identifiers received that are associated with the same link and constitute a set.

3. The method according to claim 2, wherein said determination of said interface network identifier consists in determining whether at least one of said interface identifiers received in a request is identical to one of said interface identifiers of a stored set, in order to assign to said interface that is the subject of said request an interface network identifier that is either that stored in corresponding relationship to one of said sets in the event of identity or is new in the absence of identity.

4. The method according to claim 3, wherein, in the event of assignment of a new interface network identifier, each new interface network identifier is stored in said table in said server in corresponding relationship to said received set of interface identifiers.

5. The method according to claim 3, wherein, in the event of identity between at least one of said interface identifiers received in a request and one of said interface identifiers of a stored set, whether said set of interface identifiers received is entirely identical to said stored set is determined, in order to update said stored set in the event of incomplete identity.

6. The method according to claim 4, wherein, in the event of identity between at least one of said interface identifiers received in a request and one of said interface identifiers of a stored set, whether said set of interface identifiers received is entirely identical to said stored set is determined, in order to update said stored set in the event of incomplete identity.

7. The method according to claim 1, wherein a sequence identifier is integrated into said request for assignment of an interface network identifier to enable it to be sent to said server in the form of a sequence of packets each including the same sequence identifier.

8. The method according to claim 3, wherein a sequence identifier is integrated into said request for assignment of an interface network identifier to enable it to be sent to said server in the form of a sequence of packets each including the same sequence identifier.

9. The method according to claim 4, wherein a sequence identifier is integrated into said request for assignment of an interface network identifier to enable it to be sent to said server in the form of a sequence of packets each including the same sequence identifier.

10. The method according to claim 5, wherein a sequence identifier is integrated into said request for assignment of an interface network identifier to enable it to be sent to said server in the form of a sequence of packets each including the same sequence identifier.

11. The method according to claim 1, wherein, in the event of a requirement to assign an interface network identifier for an interface connected to a link, the identifiers of the interfaces connected to the same link are determined, in the network equipment to which said interface belongs.

12. The method according to claim 3, wherein, in the event of a requirement to assign an interface network identifier for an interface connected to a link, the identifiers of the interfaces connected to the same link are determined, in the network equipment to which said interface belongs.

13. The method according to claim 4, wherein, in the event of a requirement to assign an interface network identifier for an interface connected to a link, the identifiers of the interfaces connected to the same link are determined, in the network equipment to which said interface belongs.

14. The method according to claim 5, wherein, in the event of a requirement to assign an interface network identifier for an interface connected to a link, the identifiers of the interfaces connected to the same link are determined, in the network equipment to which said interface belongs.

15. The method according to claim 7, wherein, in the event of a requirement to assign an interface network identifier for an interface connected to a link, the identifiers of the interfaces connected to the same link are determined, in the network equipment to which said interface belongs.

16. The method according to claim 11, wherein said determination is effected using a neighbor interface discovery protocol.

17. The method according to claim 16, wherein said neighbor interface discovery protocol is the NDP protocol, in which case each interface identifier determined is a link local address.

18. A server for dynamically assigning DHCP interface network identifiers for the IP configuration of interfaces of network equipments connected to an Internet protocol communication network, which server comprises processing means adapted, in the event of reception of a request to assign an interface network identifier for an interface of a network equipment connected to a link including the identifier of said interface and the interface identifiers of the other interfaces connected to the same link, for determining for said interface that is the subject of said request an interface network identifier common to all the interfaces connected to the same link, in order to transmit said interface network identifier thus determined to said network equipment that requested it in order for it to configure said interface.

19. The server according to claim 18, comprising a memory adapted to store each interface network identifier determined by said processing means in a table in corresponding relationship to the interface identifiers received and associated with the same link, which constitute a set.

20. The server according to claim 19, wherein said processing means are adapted to determine if at least one of said interface identifiers received in a request is identical to one of said interface identifiers of a set stored in said memory and then to assign to said interface that is the subject of said request an interface network identifier that is either that stored in corresponding relationship to one of said sets in the event of identity or is new in the event of absence of identity.

21. The server according to claim 20, wherein said processing means are adapted, in the event of assignment of a new interface network identifier, to store each new interface network identifier in said table of said memory in corresponding relationship to said set of interface identifiers received.

22. The server according to claim 20, wherein said processing means are adapted, in the event of identity between at least one of said interface identifiers received in a request and one of said interface identifiers of a stored set, to determine if said set of interface identifiers received is entirely identical to said stored set and then to update said stored set in said memory in the event of incomplete identity.

23. The server according to claim 21, wherein said processing means are adapted, in the event of identity between at least one of said interface identifiers received in a request and one of said interface identifiers of a stored set, to determine if said set of interface identifiers received is entirely identical to said stored set and then to update said stored set in said memory in the event of incomplete identity.

24. An IP router for an Internet Protocol communication network, comprising at least a portion of a server according to claim 18.

25. An IP router for an Internet Protocol communication network, comprising at least a portion of a server according to claim 18.

26. A network equipment for an Internet Protocol communication network including a server according to claim 18 for dynamically assigning network identifiers, said equipment including at least one interface connected to a link and associated with an interface identifier, and management means adapted, if an interface network identifier is required for said interface, to generate and to send to said server a request for assignment of an interface network identifier specifying the identifier of said interface and the interface identifiers of the other interfaces connected to said link.

27. The network equipment according to claim 26, wherein said management means are adapted to integrate into said interface network identifier assignment request a sequence identifier to enable it to be sent to said server in the form of a sequence of packets each including the same sequence identifier.

28. The network equipment according to claim 26, wherein said management means are adapted, in the event of a requirement to assign an interface network identifier for said interface, to determine said identifiers of the interfaces connected to the same link.

29. The network equipment according to claim 28, comprising determination means adapted to determine, by means of a neighbor interface discovery protocol, an identifier for said interface to be configured and identifiers for said interfaces connected to the same link as said interface to be configured, and wherein said management means are adapted, by means of said determination means, to determine the identifier of said interface to be configured and the identifiers of said other interfaces connected to the same link.

30. The network equipment according to claim 29, wherein said neighbor interface discovery protocol is the NDP protocol, each interface identifier determined then being a local link address.
